(19) United States
(12) Patent Application Publication
(10) Pub. No.: US 2005/0182653 A1
(43) Pub. Date: Aug. 18, 2005

(54) System and method for improving and promoting compliance to a therapeutic regimen

(76) Inventors: Joseph Urban, Richboro, PA (US); Mary Patricia Van Schaick, Ambler, PA (US)

Correspondence Address: RATNERPRESTIA, P O BOX 980, VALLEY FORGE, PA, 19482-0980, US

(21) Appl. No.: 10/777,253

(22) Filed: Feb. 12, 2004

(51) Int. Cl. G06F 17/60

(52) U.S. Cl. 705/2

(57) ABSTRACT

The present invention provides a method and system for improving patient compliance to prescribed therapeutic regimens by allowing the patient to participate in a system, the system being firstly authorized by the patient to initiate communication with the patient should the patient become non-compliant with the prescribed regimen. The system initiates communication with non-compliant patients through means that may include telephone, facsimile, electronic mail, text messaging, RFID, and Bluetooth®, but will not contact those users adhering to the prescribed regimen. Those users adhering to the prescribed regimen, therefore, may report compliance actively (e.g., notifying the system of compliance, thereby preventing communication from the system) or passively (e.g., through high frequency communications from sensors monitoring compliance, thereby preventing communication from the system). The system of the present invention may generally comprise a receiving means, a transmitting means, a database, and a controller coupled to the receiving means, transmitting means, and database.

### TECHNICAL FIELD

The present invention relates generally to a system for promoting compliance and improving health and, more particularly, to a system for distributing reminders for improving compliance to a medical therapy regimen.

### BACKGROUND OF THE INVENTION

When medical professionals prescribe treatment regimens for patients, a problem can arise in assuring that the patients comply with the requirements of the treatment regimen. While prescription drugs are modern miracles in preserving and extending a person's life, not taking prescriptions as required (non-compliance) has become a major health problem. For example, some patients are disorganized, forgetful, or simply unwilling to comply. When the treatment regimen has potential side effects, or when the treatment regimen is to be followed under stated conditions (e.g., taking medicine with meals, not with alcohol, or in the evening), patient compliance can be relatively reduced even further. When the treatment regimen is relatively complex, some patients are even unable or unwilling to manage that treatment regimen.

Non-compliance in prescription drug taking is putting an enormous strain on the entire health care system today. It is estimated that 90% of doctor visits produce a prescription, most of what a doctor says during a visit is forgotten, some patients never refill their prescription, and over 50% of patients do not strictly adhere to their prescribed regimen. It is estimated that greater than 15 percent of all emergency room visits are the direct result of prescription drug non-compliance. Other negative results of non-compliance include hospital and nursing home admissions as well as lost wages and lower productivity.

As the population ages, compliance becomes a source for even more concern. Population experts say by the year 2010, over 100 million Americans will be over the age of 50.

Methods and systems have already been proposed for improving compliance. For example, methods and systems are proposed in U.S. Pat. No. 5,623,242; U.S. Pat. No. 5,852,408; U.S. Pat. No. 5,623,242; and U.S. Pat. No. 6,024,699. Nevertheless, a need remains for an improved method for improving patient compliance to a therapeutic regimen.

### SUMMARY OF THE INVENTION

The present invention is embodied in a method for improving patient compliance to a therapeutic regimen, the method comprises the steps of storing identifiers and corresponding reminder protocols associated with the therapeutic regimen; receiving a communication of an identifier, a contact preference, and a reminder preference from a patient to receive the therapeutic regimen, thereby activating the reminder protocol associated with the therapeutic regimen; determining whether the patient corresponding to the received identifier requires a reminder of the therapeutic regimen according to the reminder protocol; and upon determining the patient corresponding to the received identifier requires a reminder of the therapeutic regimen according to the reminder protocol, reminding the patient of the therapeutic regimen in accordance with the contact preference and the reminder preference.

In another embodiment of the present invention, a method for improving patient compliance to a therapeutic regimen comprises the steps of distributing to a patient the therapeutic regimen and an identifier associated with the therapeutic regimen; and enabling the patient to provide the identifier, a contact preference, and a reminder preference to a reminder service, thereby activating a reminder protocol associated with the therapeutic regimen, notify the reminder service when the patient does not require a reminder of the therapeutic regimen according to the reminder protocol, and receive a reminder of the therapeutic regimen in accordance with the contact preference and the reminder preference when the patient does not notify the reminder service.

In a further embodiment of the present invention, a method for improving patient compliance to a therapeutic regimen comprises the steps of providing an identifier for distribution to a patient in connection with the therapeutic regimen and authorizing a reminder service to: receive an identifier, a contact preference, and a reminder preference from the patient to receive the therapeutic regimen, thereby activating a reminder protocol associated with the therapeutic regimen; determine whether the patient corresponding to the received identifier requires a reminder of the therapeutic regimen according to the reminder protocol; and upon determining the patient corresponding to the received identifier requires a reminder of the therapeutic regimen according to the reminder protocol, remind the patient of the therapeutic regimen in accordance with the contact preference and the reminder preference.

In a further embodiment of the present invention, a method for improving patient compliance to a therapeutic regimen comprises the steps of obtaining an identifier corresponding to the therapeutic regimen; authorizing a reminder service to activate a reminder protocol by providing an identifier, a contact preference, and a reminder preference to the reminder service; notifying the reminder service when a reminder of the therapeutic regimen according to the reminder protocol is not required; and receiving a reminder of the therapeutic regimen in accordance with the contact preference and the reminder preference when the reminder service is not notified.

In an alternate embodiment of the present invention, a system is provided for improving patient compliance to a therapeutic regimen. The system includes means for receiving an identifier, a contact preference, and a reminder preference from a patient to receive the therapeutic regimen; means for storing the identifier, contact preference, and reminder preference; means for transmitting a reminder to the patient; and means for determining whether the patient corresponding to the received identifier requires the reminder of the therapeutic regimen according to the reminder protocol and upon determining the patient corresponding to the received identifier requires the reminder of the therapeutic regimen according to the reminder protocol, activating the transmitting means to remind the patient of the therapeutic regimen in accordance with the contact preference and the reminder preference.

In a further embodiment of the present invention, a method for improving patient compliance to a therapeutic regimen comprises the steps of providing an identifier for distribution to a patient in connection with the therapeutic regimen and authorizing a reminder service to monitor the extraction of a dose or the omission of the extraction of the dose through monitoring means, and at a predetermined time after monitoring an omission of the extraction, reminding the patient of the therapeutic regimen in accordance with a contact preference and a reminder preference.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. This invention is not limited to the embodiments selected for illustration in the drawing. Included in the drawing are the following figures:

FIG. 1 is a flow diagram illustrating the interaction of a treatment provider, a medical professional, a system user, and a system administrator, according to an exemplary embodiment of the present invention;

FIG. 2 is a flow diagram illustrating the generation of treatment identification codes, treatment verification and validation, and the interaction between involved parties, according to another exemplary embodiment of the present invention;

FIG. 3 is a flow diagram illustrating the interaction of a clearing house, a manufacturer, a wholesaler, a pharmacy, a patient, a doctor, and an IVR system and administrator, according to still another exemplary embodiment of the present invention;

FIG. 4 is a block diagram illustrating an apparatus according to an exemplary embodiment of the present invention; and

FIG. 5 is a flow chart illustrating the procedure used by a patient to setup and/or maintain reminders through an IVR system, according to yet another exemplary embodiment of the present invention.

### DETAILED DESCRIPTION OF THE INVENTION

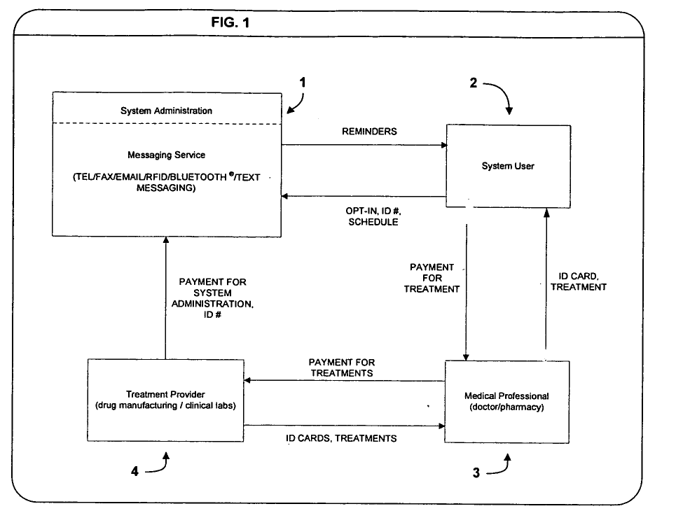

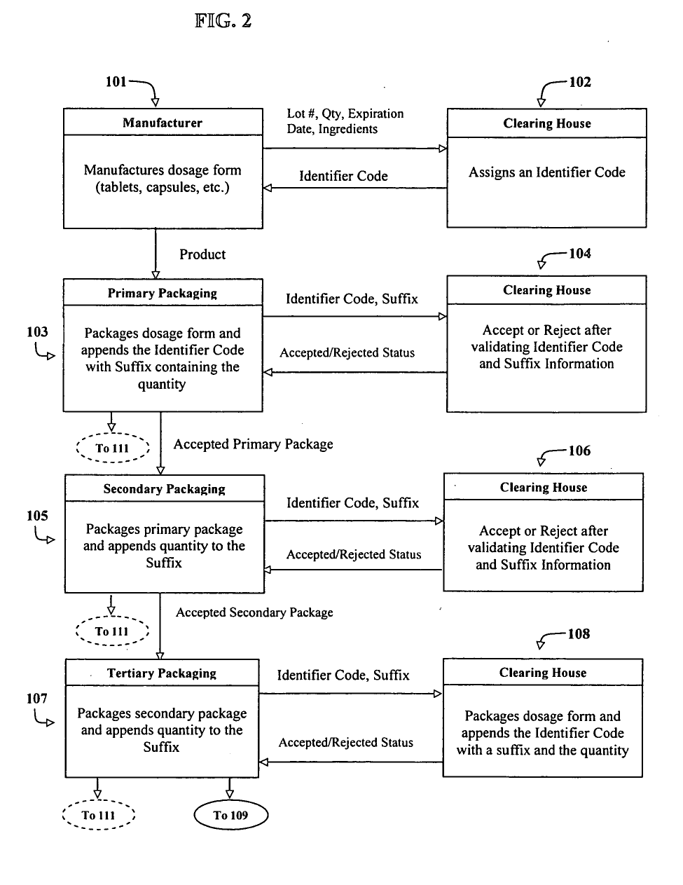

Referring now, generally, to the drawing, FIG. 1 is a flow diagram illustrating the broad interaction of parties in one embodiment of the present invention for improving patient compliance to a therapeutic regimen. A method according to one such embodiment may include a patient (i.e., system user) 2 that visits a medical professional (e.g., doctor, pharmacist, therapist, clinician, etc.) 3 in order to obtain a medical treatment and associated regimen as well as an ID card containing an identifier corresponding to the therapeutic regimen, where payment may be made for the medical treatment only. The user may then authorize a reminder service (e.g., messaging service) 1 to activate a reminder protocol by providing the ID card's identifier, their own contact preference, and their own reminder preference to the reminder service 1. System user 2 may preclude reminders from reminder service 1 by notifying the reminder service 1 when a reminder of the therapeutic regimen according to the reminder protocol is not required. If, however, such a notification is not sent, then system user 2 receives a reminder of the therapeutic regimen in accordance with the contact preference and the reminder preference by reminder service 1.

In a further embodiment of the invention, system user 2 obtains a prescription medication from medical professional 3, where notifying reminder service 1 when the patient has taken the prescription medication indicates that a reminder is not required, and system user 2 receives a reminder to take the prescription medication when reminder service 1 is not notified.

In another embodiment, system user 2 may be provided with a cellular transmitter, where notifying reminder service 1 comprises activating the cellular transmitter to notify reminder service 1 when a reminder is not needed. Such a cellular transmitter may be a handheld device equipped with cellular capability, for example, where a cellular message is transmitted to notify reminder service 1 that a reminder is not needed. Cellular-enabled handheld devices include, for example, the Treo 600 smart phone available from PalmOne and the SCH-i600 smart phone available from Samsung.

Still referring to the embodiment illustrated in FIG. 1, medical professional 3 distributes to a patient (i.e., system user) 2 the therapeutic regimen and an identifier associated with the therapeutic regimen. This generally enables the patient 2 to provide the identifier, a contact preference, and a reminder preference to a reminder service (e.g., messaging service) 1, thereby activating a reminder protocol associated with the therapeutic regimen. Furthermore, patient 2 may notify reminder service 1 when they do not require a reminder of the therapeutic regimen according to the reminder protocol, where they will receive a reminder of the therapeutic regimen in accordance with the contact preference and the reminder preference when they do not notify reminder service 1.

In a further embodiment, medical professional 3 may also provide to patient 2 contact information for reminder service 1, wherein such contact information may include a telephone number, an electronic mail address, an internet website address, a text messaging address, and/or a facsimile number, for example. In an alternate embodiment, medical professional 3 may provide a high frequency transceiver to patient 2, where such a transceiver may be an RFID transmitter. Furthermore, it may be desirable for medical professional 3 to authenticate the identifier being provided to patient 2 by forwarding the identifier to a clearing house (not shown in FIG. 1) and receiving an approval status for the identifier from the clearing house.

In an embodiment where the therapeutic regimen provided to patient 2 by medical professional 3 is a prescription medication, medical professional 3 accepts payment for the prescription medication and provides patient 2 with the prescription medication in addition to an identification device such as an ID card containing an identifier associated with the prescription medication. This serves to enable patient 2 to activate a reminder protocol associated with a prescription medication, notify reminder service 1 when they have taken the prescription medication, and receive a reminder to take the prescription medication when they do not notify reminder service 1.

It may be recognized by those in the art that the therapeutic regimen being administered by medical professional 3 may generally include a prescription medication, a physical therapy, a diagnostic or clinical test, an over-the-counter (OTC) medication, a vitamin regimen, a neutraceutical regimen, a preventive medication, a lifestyle regulation, or monitoring some function, or to activate or use a device, for example.

In the embodiment illustrated in FIG. 1, treatment provider 4 may generally be a pharmaceutical firm, a therapy center, a clinical lab, or, generally, any manufacturer of therapeutic supplies and products or provider of therapeutic services. In such an embodiment, treatment provider 4 provides, in return for payment, therapeutic treatment, drugs, supplies, etc. to medical professional 3 for distribution or delivery to patient 2. Treatment provider 4 may also provide an identifier for distribution to patient 2 in connection with a therapeutic regimen, whereby treatment provider 4 authorizes reminder service 1 to receive the identifier, a contact preference, and a reminder preference from patient 2, and thereby activating a reminder protocol associated with the therapeutic regimen. Reminder service 1 is further authorized to determine whether patient 2 corresponding to the received identifier requires a reminder of the therapeutic regimen according to the reminder protocol, whereby upon determining that patient 2 requires a reminder of the therapeutic regimen, reminder service 1 reminds patient 2 of the therapeutic regimen in accordance with the contact preference and the reminder preference.

In a further embodiment, the steps taken by treatment provider 4 to provide the identifier associated with a therapeutic regimen for distribution to medical professional 3, and ultimately, to patient 2, may further include producing the therapeutic regimen and sending product information corresponding to the therapeutic regimen to a clearing house (not shown in FIG. 1), receiving the identifier in connection with the therapeutic regimen from the clearing house, and transferring the therapeutic regimen and corresponding identifier to one of a packager, a wholesaler, and a retailer (not shown in FIG. 1). It is recognized by those skilled in the art that the packager may be a firm, factory, or agent of treatment provider 4, and the wholesaler and retailer may be medical professional 3 (e.g., doctor, pharmacy, medical supply store, etc.).

In an alternate embodiment, treatment provider 4 may provide a high frequency transceiver for distribution to the patient. The high frequency transceiver may be an RFID transmitter, for example, for transmitting signals that alert reminder service 1 when patient 2 has complied with the therapeutic regimen, thereby optionally automatically precluding reminder service 1 from issuing a reminder to patient 2.

In the embodiment illustrated generally by FIG. 1, messaging service (e.g., reminder service) 1 may be maintained by a system administrator internal to or related to messaging service 1. It may be recognized by those skilled in the art that the system administrator may also be a manual or other operator external to messaging system 1. Generally, however, the system administrator is an automated software system, such as an Interactive Voice Response (IVR) system. The system administrator according to one embodiment is configured for storing identifiers and corresponding reminder protocols associated with a therapeutic regimen. The system administrator is also configured for receiving a communication of an identifier, a contact preference, and a reminder preference from patient 2 to receive the therapeutic regimen, thereby activating the reminder protocol associated with the therapeutic regimen.

The system administrator is further configured for determining whether patient 2 corresponding to the received identifier requires a reminder of the therapeutic regimen according to the reminder protocol. Upon determining patient 2 corresponding to the received identifier requires a reminder of the therapeutic regimen according to the reminder protocol, the system administrator is configured for reminding patient 2 of the therapeutic regimen in accordance with the contact preference and the reminder preference.

Messaging service 1 may remind patient 2 by sending a reminder communication to at least one of a telephone number, an electronic mail address, a text messaging address, and a facsimile number. It may be desirable for messaging service 1 to further authenticate the received identifier by forwarding the received identifier to a clearing house (not shown in FIG. 1) and receiving an approval status for the received identifier from the clearing house. Messaging service 1 may further store the identifiers and corresponding reminder protocols in a database.

In one embodiment of the invention, the step of receiving the identifier, the contact preference, and the reminder preference may include receiving said information via a telephone communication, a facsimile communication, an RFID communication, a text message, and a Bluetooth® communication. Further, the determining step may include determining whether patient 2 has communicated compliance to the therapeutic regimen. The reminding step may include reminding patient 2 to take a medication according to a prescription, engage in a physical therapy, take a diagnostic test, or take an OTC medication, a vitamin regimen, a neutraceutical regimen, or a preventive medication, to monitor some function, to regulate or to report a lifestyle function, or to activate or use a device, for example.

Referring now to the specific figures selected to illustrate exemplary embodiments of this invention, FIG. 1 is a flow diagram illustrating a broad interaction of parties according to one embodiment of the present invention. In the present embodiment, a system user 2 obtains treatment (e.g., a prescription medication, therapy, diagnostic or clinical tests, etc.), a therapeutic regimen (e.g., a schedule for taking prescription medication, undergoing therapy, taking diagnostic or clinical tests, etc.) associated with the treatment, and an ID card or other device having an ID number associated with the treatment and contact information for a reminder service.

Medical professional 3 (e.g., doctor, pharmacist, therapist, clinician, etc.) provides the treatment in return for payment directly from system user 2 or indirectly via a third party insurer. Treatment provider 4 (e.g., drug manufacturer, clinical lab, pharmacy, manufacturer of orthopedic supplies, etc.) produces and provides the treatments and associated ID cards to medical professional 3 in return for payment for the treatments. The ID numbers contained on the ID cards are also submitted to system administrator 1 by treatment provider 4, thereby authorizing system administrator 1 to enable system user 2 to enroll in messaging service via system administrator 1. Treatment provider 4 may further provide payment to system administrator 1 for enrollment in the messaging service.

Upon receiving an ID card or other device or information associated with a treatment, system user 2 may contact messaging service 1 to provide their ID number (or other identifier), an opt-in signal, and a preferred reminder schedule. System administrator 1 authenticates the provided identifier itself or with the use of a clearing house (not shown in FIG. 1). Upon receiving an approved status of the identifier from the clearing house, system administrator 1 stores the identifier and associated reminder schedule to a database, if system user 2 has indicated an affirmative opt-in signal.

Upon storing the identifier and reminder schedule to the database, messaging service 1 is thereby authorized to initiate communication with system user 2 to provide reminders to system user 2 to comply with the prescribed therapeutic regimen. Such a reminder may be sent through one or more of a telephone communication, a facsimile communication, a text message, and an electronic mail message. In a further embodiment, system user 2 may initiate communication with messaging service 1 to indicate compliance with the prescribed therapeutic regimen, thereby precluding messaging service 1 from providing a reminder to system user 2 or eliminating a need for such a reminder. System user 2 may provide such an indication of compliance by initiating one of a telephone communication, a facsimile communication, a text message, or an electronic mail message.

In an alternate embodiment, system user 2 may provide such an indication through transmission of a high frequency signal such as an RFID signal or, alternately, a Bluetooth® signal. In such an embodiment, patient compliance to a therapeutic regimen may be improved by providing an identifier for distribution to patient 2 in connection with the therapeutic regimen, and authorizing a reminder service to monitor the patient's compliance with the therapeutic regimen.

Such monitoring can be accomplished by detecting an action of the system user 2 with respect to a treatment. For example, the manipulation of a structure associated with the treatment is optionally monitored by the reminder service. In one exemplary embodiment, the extraction of a dose of medication (or the omission of the extraction of the dose) from a package is optionally communicated to the reminder service. Upon removal of the dose from the package (such as a blister package), a transmitter associated with the package (e.g., positioned in or adjacent to a blister) sends a message to the reminder service. Such a transmitter therefore provides one form of monitoring means.

If such a signal is transmitted to the reminder service (indicating that the patient is in compliance with the therapy regimen), then a reminder need not be issued by the reminder service. At a predetermined time after monitoring an omission of the extraction, however, the reminder service is configured for reminding the patient of the therapeutic regimen in accordance with a contact preference and a reminder preference provided by the user.

Those skilled in the art may recognize that, generally, any radio wave, microwave, magnetic impulse, electrical current, short wave, or long wave transmissions may be used to monitor the extraction of a dose and to provide an indication of compliance by system user 2 to messaging service 1. For example, system user 2 may open the blister package (as described above) or a vial having means for monitoring extraction of a dose and containing a number of doses of a prescribed medication. When a user extracts a dose from the blister package or vial, the means for monitoring (which may include transmissions described above) will activate a signal to messaging service 1, indicating compliance of system user 2. Industry standards for such transmissions that may be used by the present embodiment may include, but are not limited to, RFID, Bluetooth®, Wi-Fi (i.e., IEEE 802.11), short-range infrared impulses, GSM, and cellular technologies (i.e., CDMA, TDMA, etc.).

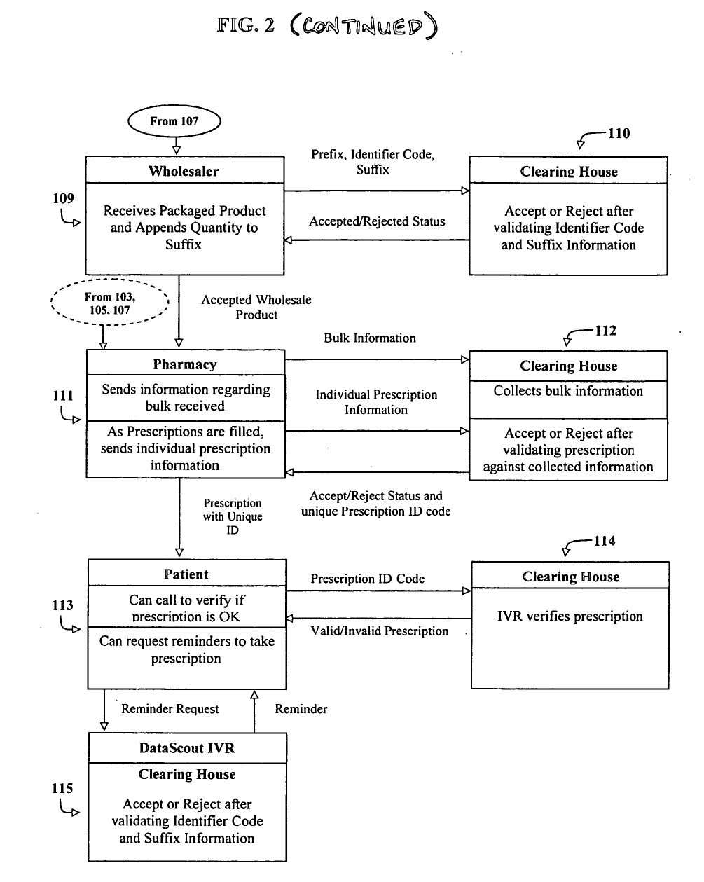

FIG. 2 is a flow diagram illustrating one embodiment of the present invention for the production and authentication of identifiers such as ID numbers. In this example, the treatment provider is a Pharmaceutical Manufacturer. It is contemplated that the treatment provider can be any organization that provides or produces a treatment in any form. The treatment is optionally in the form of a product or a service.

In step 101, the Pharmaceutical Manufacturer or an agent of the Pharmaceutical Manufacturer produces dosage form (tablets, capsules, elixirs, syrups, etc.) and sends product information (e.g., lot number, quantity, expiration date, ingredients, etc.) to a Clearing House that serves as the Ombudsman. A candidate organization for the Clearing House may be the United States Pharmacopoeia (USP).

In step 102, the Clearing House assigns a unique code to the product to identify the treatment by batch or otherwise and then transmits this Identifier Code back to the Pharmaceutical Manufacturer. Then, in step 103, the Pharmaceutical Manufacturer sends the product to the Primary Packager. The Primary Packager packages the dosage form. The dosage form may be a blister-card, bottle, or bulk packaging, for example. The Primary Packager appends a Suffix that includes the packaged quantity to the Identifier Code and then transmits this appended Identifier Code to the Clearing House.

The Clearing House validates the information in the Identifier Code and Suffix in step 104 to determine if the packaged product should be rejected or accepted. If the packaged quantity does not match the batch quantity or other parameter, or if the expiration date has passed, then the packaged product is rejected. Upon validation, the Clearing House transmits a Rejected or Accepted status back to the Primary Packager.

The accepted primary package is then sent to the Secondary. Packager. In step 105, the Secondary Packager packages the primary package into boxes or other packaging units and appends the packaged quantity to the Identifier Code Suffix. The Identifier Code and Suffix are then transmitted to the Clearing House for validation.

The Clearing House validates the information in the Identifier Code and Suffix in step 106 to determine if the packaged product (as packaged by the Secondary Packager) should be rejected or accepted. If the packaged quantity does not match the batch quantity or other parameter, or if the expiration date has passed, then the packaged product is rejected. Upon validation, the Clearing House then transmits a Rejected or Accepted status back to the Secondary Packager.

The accepted secondary package is sent by the Secondary Packager to the Tertiary Packager, whereby in step 107, the Tertiary Packager packages the secondary package and appends the packaged quantity to the Identifier Code Suffix. The Identifier Code and Suffix are then transmitted to the Clearing House for validation.

In step 108, the Clearing House validates the information in the Identifier Code and Suffix to determine if the packaged product should be rejected or accepted. If the packaged quantity does not match the batch quantity or other parameter, or if the expiration date has passed, then the packaged product is rejected. The Clearing House then transmits a Rejected or Accepted status back to the Tertiary Packager.

The accepted tertiary package is sent by the Tertiary Packager to the Wholesaler. Then, in step 109 the Wholesaler adds a prefix to the Identifier Code and transmits the Prefix, Identifier Code and Suffix to the Clearing House for validation.

The Clearing House validates the information in the Prefix, Identifier Code and Suffix in step 110 to determine if the wholesale product should be rejected or accepted. If the packaged quantity does not match the batch quantity etc., or if the expiration date has passed, then the wholesale product is rejected. The Clearing House then transmits a Rejected or Accepted status back to the Wholesaler.

Those skilled in the art will recognize that other criteria for acceptance/rejection of the packaged quantity may be developed without departing from the invention. Furthermore, it may recognized that the manufacturer, primary packager, secondary packager, tertiary packager, and wholesaler may correspond to a single entity or a plurality of entities or their agents. Additionally, one or more of the primary packaging, secondary packaging, and tertiary packaging steps may be omitted or replaced by a single equivalent step (not shown in FIG. 2). Accordingly, as shown in phantom, one or more of steps 103, 105, and 107 may proceed directly to step 111, thereby omitting one or more intermediate packaging and wholesale steps.

In step 111, the accepted product is sent to the retailer such as a Pharmacy, which transmits information regarding the bulk received to the Clearing House. The pharmacy then fills prescriptions for this product and transmits individual prescription information to the Clearing House for approval.

The Clearing House validates the information to determine if the prescription is valid, in step 112. Validation tests include verifying that the Pharmacy has sufficient quantity on hand to dispense the prescription. The Clearing House then transmits a Rejected or Approved status back to the Pharmacist. For Approved prescriptions, the Clearing House also sends back a unique prescription Identifier Code.

In step 113, the approved prescription is dispensed to the recipient of the treatment such as a Patient. The Patient may then call the Clearing House messaging service (such as an IVR) and enter the prescription Identifier Code into the messaging system to verify that the prescription received is valid. At this point, the Patient may also register with the IVR system to receive reminders to take the prescribed drug.

IVR systems suitable for use according to this invention are available from DataScout LLC, which offers an interactive voice response system. Other IVR systems are also available including the ClinPhone® IVR system available from ClinPhone Group Ltd., the Dynarand® IVR system available from Dynarand, LLC the IVR system available from Interactive Clinical Technologies, Inc. etc. if so modified.

In step 114, the IVR system verifies the prescription identifier code and reports a valid or invalid status to the patient. Finally, in step 115, the IVR system calls the patient to remind him/her to take the prescribed medicine. The reminder calls are performed on a regular basis according to the patient's desired reminder times, which may have been designated in step 113. For example, in the instance of a prescribed medicine, the treatment or therapy regimen may comprise the number of days the medication is to be taken, the number of intervals the medication is to be taken each day and the duration of such intervals, and the dosage (e.g., number of pills) to be taken at each interval. The regimen may also comprise guidelines for taking the medication to optimize its efficacy, safety, or patient comfort. Reminder messages may therefore be provided one or more times each day during the course of the therapy regimen.

The IVR also tracks how many dosages remain so that it will stop calling after the prescription is complete. Optionally, the IVR may call with prescription refill reminders when it determines the patient's supply of the prescription is running low or is complete. In a further embodiment of the invention, a patient that has taken his/her prescription prior to receiving a reminder from the IVR system may call the IVR system to provide an indication of compliance and to cancel the forthcoming unnecessary reminder.

In an alternate embodiment in accordance with the embodiment of FIG. 2, the clearing house may obtain, from a provider of the prescription medication, product information associated with the prescription medication, assign a code to the prescription medication associated with the product information, and validate the code. The clearing house can optionally provide one of an accepted and rejected status to the provider of the prescription medication in response to a validation request.

Accordingly, the provider of the prescription medication may produce the prescription medication and send product information corresponding to the prescription medication to the clearing house, receive the code associated with the prescription medication from the clearing house, package the prescription medication, transmit product information associated with the packaged prescription medication to the clearing house for validation, and transfer the prescription medication and associated code to one of a wholesaler and a retailer for distribution to patients (or directly to patients) upon further validation by the clearing house.

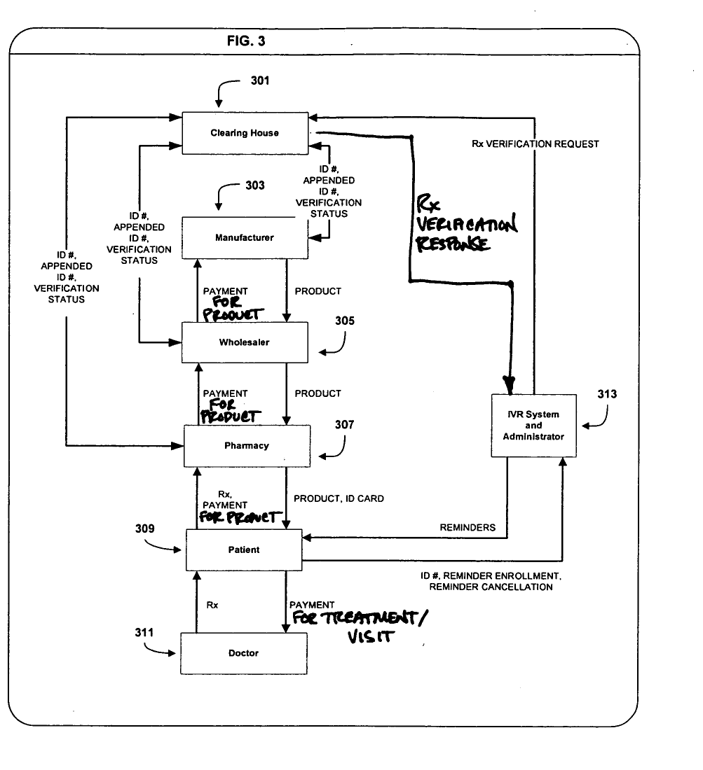

FIG. 3 is a flow diagram illustrating the specific interaction of parties in a further embodiment of the present invention. Manufacturer 303 produces a product (e.g., drug, medical equipment, etc.) and transmits product information (e.g., lot number, expiration date, ingredients) associated with the product to clearing house 301. Clearing house 301 then generates an identifier such as an ID number corresponding to the product having product information and transmits the ID number back to manufacturer 303. The interaction between manufacturer 303 and clearing house 301 may further be expanded to include the description of FIG. 2, whereby interaction between clearing house 301, manufacturer 303, and one or more packagers (not shown in FIG. 3) results in appended ID numbers.

Manufacturer 303 then receives payment for the product from wholesaler 305, whereupon the product and associated ID number are transferred to wholesaler 305. Wholesaler 305 may then authenticate the product and ID number with clearing house 301. Upon receiving a verification status indicating approval from clearing house 301, wholesaler 305 may then accept payment for the product from a retailer, such as pharmacy 307. Pharmacy 307 then receives the product with its associated ID number.

Patient 309, in the meantime, presents payment for treatment/visit to a medical professional, such as doctor 311, whereby doctor 311 provides a prescription or therapeutic regimen to be followed by patient 309. Patient 309 may then proceed to fill their prescription at pharmacy 307 by providing payment for the prescribed treatment and the prescription provided by doctor 311. Upon reception of the prescription from patient 309, pharmacy 307 may provide product information associated with the prescribed treatment to clearing house 301 for authentication. Clearing house 301 then may provide to pharmacy 307 a verification status indicating approval, whereby pharmacy 307 may then provide patient 309 with the product in addition to an ID card containing the ID number or other identifier. Still patient 309 may call clearing house 301 to ascertain authenticity of the medication just received.

In an alternate embodiment, clearing house 301 may provide a new prescription identifier or ID number that is transferred, along with the verification status, to pharmacy 307 and ultimately provided to patient 309 via the ID card or other device. The ID card may further contain contact information for interactive voice recognition (IVR) system and administrator 313.

Patient 309 may then contact IVR system 313 to provide their ID number or identifier, enroll in a reminder service, and provide a preferred reminder schedule. The preferred reminder schedule includes, for example, a time of day that the patient 309 would like to receive a reminder if a reminder is necessary. Upon reception of the ID number from patient 309, IVR system 313 may transmit a prescription verification request to clearing house 301. Upon receiving a verification response indicating approval, patient 309 may then be enrolled in the IVR reminder service.

In such a service; IVR system 313 will contact patient 309 to provide reminders to comply with the prescribed treatment and therapeutic regimen according to the preferred reminder schedule. Patient 309 may preclude IVR system 313 from providing such reminders, however, by proactively contacting IVR system 313 to provide an indication of compliance, thereby canceling a forthcoming reminder.

In a further embodiment, patient 309 may opt to cancel enrollment in the reminder service altogether. Also, IVR system 313 may provide reminders when it is determined that the prescribed treatment of patient 309 is in need of a refill (e.g., when the prescribed treatment is a prescription medication). Such a determination may be made from data stored by clearing house 301 (i.e., the original ID number corresponds to the product having a certain quantity, therefore, IVR system 313 may keep count of the number of doses taken by patient 309 in relation to the number of doses in the product given to patient 309).

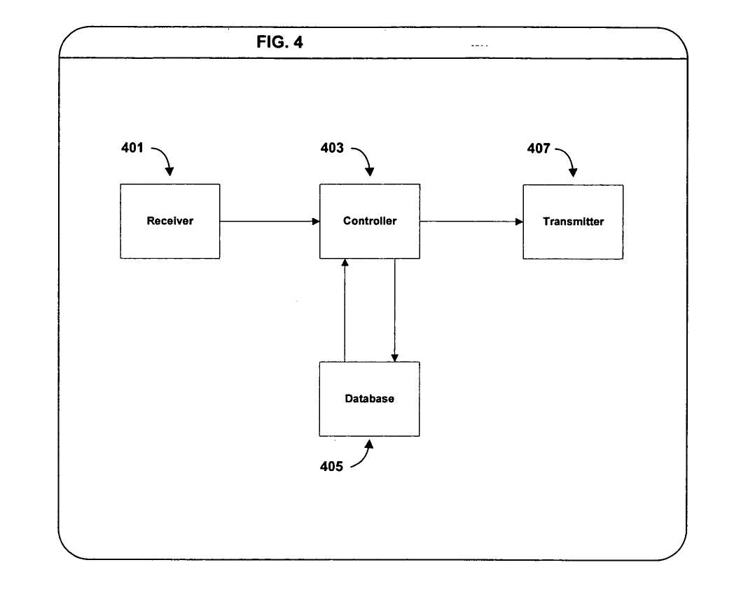

FIG. 4 illustrates an apparatus according to the present invention. The apparatus is for improving patient compliance to a therapeutic regimen and comprises means for receiving 401 an identifier, a contact preference, and a reminder preference from a patient; means for storing 405 the identifier, contact preference, and reminder preference; means for transmitting 407 a reminder to the patient; and means for determining 403 whether the patient corresponding to the received identifier requires the reminder of the therapeutic regimen according to the reminder protocol and, upon determining the patient corresponding to the received identifier requires the reminder of the therapeutic regimen according to the reminder protocol, activating the transmitting means to remind the patient of the therapeutic regimen in accordance with the contact preference and the reminder preference.

Means for receiving 401 may generally include one of a telephone receiver, a facsimile receiver, a pager, or an electronic mail receiver, for example. Alternately, receiving means 401 may be a high frequency receiver such as an RFID receiver. Means for transmitting 407 may generally include one of a telephone transmitter, a facsimile transmitter, a pager, and an electronic mail transmitter. Alternately, transmitting means 407 may be a high frequency transmitter such as an RFID transmitter. As previously mentioned, receiving and transmitting means may include transmitters, receivers, and transceivers for many industry standards for such transmissions as RFID, Bluetooth®, Wi-Fi (i.e., IEEE 802.11), short-range infrared impulses, GSM, and cellular technologies (i.e., CDMA, TDMA, etc.).

In the embodiment illustrated in FIG. 4, communications from a patient are received by receiver 401 and are then transmitted to controller 403. Controller 403 may then authenticate the received information (not shown in FIG. 4), and may then store the received information to database 405. Upon determining that a communication must be made to a patient having information stored in database 405, controller 403 will initiate a request to transmitter 407 to provide a communication to the patient, providing a reminder to the patient to comply with a therapeutic regimen. If, however, receiver 401 receives a prior indication of compliance by a patient, such an indication may be stored in database 405 by controller 403, thereby affecting the determination described above.

It is recognized by those skilled in the art that for many communications systems that may be employed by the present invention for reception and transmission of communications signals, receiver 401 and transmitter 407 may generally be a transceiver housed in a single unit. Such a device may further have a plurality of communications channels available for reception and transmission of a plurality of simultaneous communications signals.

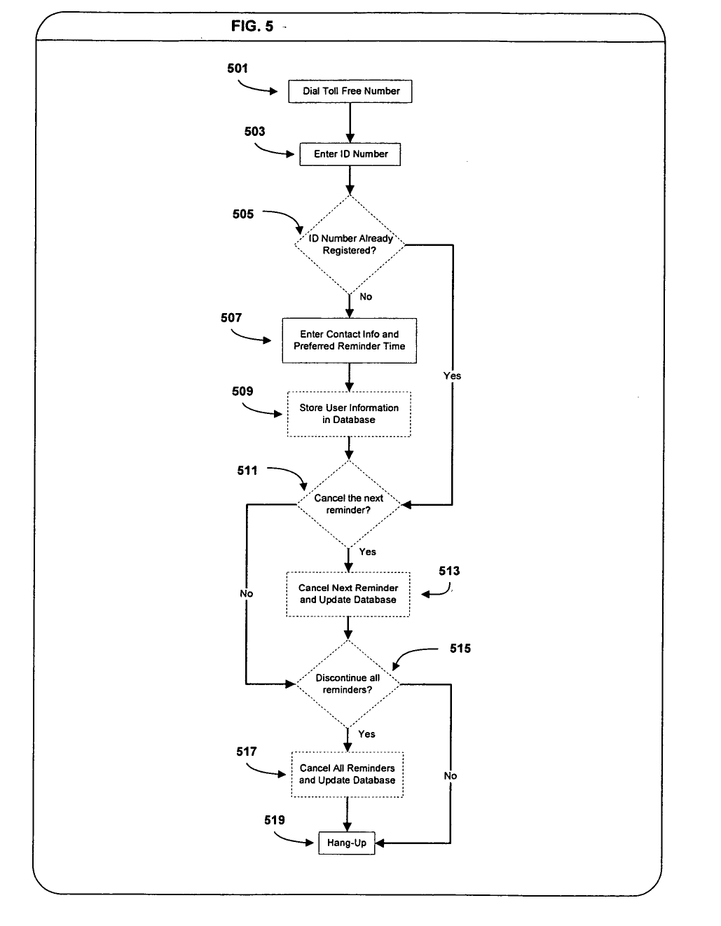

Referring now to FIG. 5, a flow chart is presented illustrating one embodiment of user interaction with the IVR system mentioned above. In such an embodiment, a user may sign up to receive reminders to take a prescribed product by first communicating with the IVR system such as by dialing a toll free number in step 501, corresponding to a contact number of the IVR system that was provided by the user's pharmacist and/or the pharmaceutical company or other party associated with the prescribed product. Upon connection of the call and reception of a prompt, the user may enter their unique identification number in step 503.

In step 505, shown in phantom to denote a system step transparent to the user, the IVR system checks its database to determine if the provided identification number has already been registered. If the identification number has not yet been registered, the user is prompted in step 507 to enter contact information where they may receive reminders from the IVR system, as well as a preferred reminder time when they would like to be reminded by the IVR system. In an alternate embodiment, the IVR system may proceed to transmit the ID number to a clearing house for authentication. If a preferred reminder time is not provided in step 507, a default reminder time may be assigned.

The contact information entered by the user may include one or more of a telephone number, a facsimile number, an electronic mail address, an instant messaging username, or any other equivalent means of communication. In system step 509, the user's provided information is stored into the IVR system database.

In a user's registration call to the IVR system (i.e., if the answer to step 505 was no), the system may automatically proceed to step 519 after step 509. However, in an alternate embodiment, the user may be prompted in step 511 if they would like to cancel their next reminder. If in step 505 it is determined that a user is already registered, then the process may proceed to step 511 directly to prompt the user. Alternatively, the system may automatically cancel the next reminder and proceed to step 519. If the decision is made in step 511 to cancel the user's next reminder, step 513 proceeds to cancel the next reminder and update the IVR database accordingly.

An optional step 515 may be presented to the user whereby they may opt to discontinue all further reminders and cancel their enrollment in the system. If the user opts to do so, step 517 cancels all reminders for the user and updates the database accordingly. In step 519, the call between the user and the IVR system is disconnected. In a further embodiment, it may be desirable to include one or more further prompts whereby the user may update their contact information and/or their preferred reminder time. Another embodiment may include a prompt to enroll or cancel enrollment in a prescription refill reminder service, whereby the IVR system communicates reminders to the user when it is determined that the user's prescription is in need of a refill.

Although illustrated and described above with reference to certain specific embodiments, the present invention is nevertheless not intended to be limited to the details shown. Rather, various modifications may be made in the details within the scope and range of equivalents of the claims and without departing from the invention.

1. A method for improving patient compliance to a therapeutic regimen, said method comprising the steps of:
(a) storing identifiers and corresponding reminder protocols associated with the therapeutic regimen;
(b) receiving a communication of an identifier, a contact preference, and a reminder preference from a patient to receive the therapeutic regimen, thereby activating the reminder protocol associated with the therapeutic regimen;
(c) determining whether the patient corresponding to the received identifier requires a reminder of the therapeutic regimen according to the reminder protocol; and
(d) upon determining the patient corresponding to the received identifier requires a reminder of the therapeutic regimen according to the reminder protocol, reminding the patient of the therapeutic regimen in accordance with the contact preference and the reminder preference.

2. The method according to claim 1, wherein the step of reminding the patient includes sending a reminder communication to at least one of a telephone number, an electronic mail address, and a facsimile number.

3. The method according to claim 1, further including the step of authenticating the received identifier.

4. The method according to claim 3, wherein said authenticating step includes the steps of forwarding the received identifier to a clearing house and receiving an approval status for the received identifier from the clearing house.

5. The method according to claim 1, wherein said storing step includes storing the identifiers and corresponding reminder protocols in a database.

6. The method according to claim 1, wherein said receiving step includes receiving the identifier, the contact preference, and the reminder preference via a telephone communication.

7. The method according to claim 1, wherein said determining step comprises determining whether the patient has communicated compliance to the therapeutic regimen.

8. The method according to claim 1, wherein said reminding step comprises reminding the patient to take a medication according to a prescription, engage in a physical therapy, take a diagnostic test, take OTC medication, take a vitamin regimen, take a neutraceutical regimen, take a preventive medication, monitor a function, regulate or report a lifestyle function, or to activate or use a device.

9. A method for improving patient compliance to a therapeutic regimen, said method comprising the steps of:
(a) distributing to a patient the therapeutic regimen and an identifier associated with the therapeutic regimen;
(b) enabling the patient to:
(i) provide the identifier, a contact preference, and a reminder preference to a reminder service, thereby activating a reminder protocol associated with the therapeutic regimen;
(ii) notify the reminder service when the patient does not require a reminder of the therapeutic regimen according to the reminder protocol; and
(iii) receive a reminder of the therapeutic regimen in accordance with the contact preference and the reminder preference when the patient does not notify the reminder service according to step (b)(ii).

10. The method according to claim 9, wherein step (b) further includes providing, to the patient, contact information for the reminder service.

11. The method according to claim 10, wherein said providing step includes providing one or more of a telephone number, an electronic mail address, and a facsimile number.

12. The method according to claim 10, wherein said providing step includes providing a high frequency transceiver.

13. The method according to claim 9, further including the step of authenticating the identifier.

14. The method according to claim 13, wherein authenticating the identifier includes the steps of forwarding the identifier to a clearing house and receiving an approval status for the identifier from the clearing house.

15. The method according to claim 9, wherein said distributing step comprises distributing to the patient a prescription medication, a physical therapy, a diagnostic test, an OTC medication, a vitamin regimen, a neutraceutical regimen, a preventive medication, or instructions for monitoring a function, regulating or reporting a lifestyle function, or activating or using a device.

16. The method according to claim 9, wherein step (b) comprises enabling the patient to:
(i) activate a reminder protocol associated with a prescription medication;
(ii) notify the reminder service when the patient has taken the prescription medication; and
(iii) receive a reminder to take the prescription medication when the patient does not notify the reminder service according to step (b)(ii).

17. A method for improving patient compliance to a therapeutic regimen, said method comprising the steps of:
(a) providing an identifier for distribution to a patient in connection with the therapeutic regimen;
(b) authorizing a reminder service to:
(i) receive an identifier, a contact preference, and a reminder preference from the patient to receive the therapeutic regimen, thereby activating a reminder protocol associated with the therapeutic regimen;
(ii) determine whether the patient corresponding to the received identifier requires a reminder of the therapeutic regimen according to the reminder protocol; and
(iii) upon determining the patient corresponding to the received identifier requires a reminder of the therapeutic regimen according to the reminder protocol, remind the patient of the therapeutic regimen in accordance with the contact preference and the reminder preference.

18. The method according to claim 17, wherein step (a) includes the steps of:
(i) producing the therapeutic regimen and sending product information corresponding to the therapeutic regimen to a clearing house,
(ii) receiving the identifier in connection with the therapeutic regimen from the clearing house; and
(iii) transferring the therapeutic regimen and corresponding identifier to one of a packager, a wholesaler, and a retailer.

19. The method according to claim 17, wherein said providing step comprises providing the identifier for distribution to the patient by a pharmacy in connection with a prescription medication.

20. The method according to claim 19, wherein said authorizing step comprises authorizing the reminder service to activate the reminder protocol associated with the prescription medication, determine whether the patient requires a reminder to take the prescription medication, and remind the patient to take the prescription medication upon determining the patient requires the reminder.

21. The method according to claim 17, wherein said providing step comprises providing a high frequency transceiver for distribution to the patient.

22. A method for improving patient compliance to a therapeutic regimen, said method comprising the steps of:
(a) obtaining an identifier corresponding to the therapeutic regimen;
(b) authorizing a reminder service to activate a reminder protocol by providing an identifier, a contact preference, and a reminder preference to the reminder service;
(c) notifying the reminder service when a reminder of the therapeutic regimen according to the reminder protocol is not required; and
(d) receiving a reminder of the therapeutic regimen in accordance with the contact preference and the reminder preference when the reminder service is not notified according to step (c).

23. The method according to claim 22, wherein said obtaining step comprises obtaining a prescription medication, said notifying step comprises notifying the reminder service when the patient has taken the prescription medication, and said receiving step comprises receiving a reminder to take the prescription medication when the reminder service is not notified according to said notifying step.

24. The method according to claim 22, wherein said obtaining step comprises obtaining a high frequency transmitter and said notifying step comprises activating the high frequency transmitter to notify the reminder service when the reminder service is not needed.

25. A system for improving patient compliance to a therapeutic regimen, the system comprising:
means for receiving an identifier, a contact preference, and a reminder preference from a patient to receive the therapeutic regimen;
means for storing the identifier, contact preference, and reminder preference;
means for transmitting a reminder to the patient; and
means for
determining whether the patient corresponding to the received identifier requires the reminder of the therapeutic regimen according to the reminder protocol, and
upon determining the patient corresponding to the received identifier requires the reminder of the therapeutic regimen according to the reminder protocol, activating the transmitting means to remind the patient of the therapeutic regimen in accordance with the contact preference and the reminder preference.

26. The system of claim 25, wherein said receiving means includes one of a telephone receiver, a facsimile receiver, a pager, or an electronic mail receiver.

27. The system of claim 25, wherein said receiving means includes a high frequency receiver.

28. The system of claim 25, wherein said transmitting means includes one of a telephone transmitter, a facsimile transmitter, a pager, and an electronic mail transmitter.

29. The system of claim 25, wherein said transmitting means includes a high frequency transmitter.

30. A method for improving patient compliance to a therapeutic regimen, said method comprising the steps of:
(a) providing an identifier for distribution to a patient in connection with the therapeutic regimen; and
(b) authorizing a reminder service to:
(i) monitor the extraction of a dose or the omission of the extraction of the dose through monitoring means; and
(ii) at a predetermined time after monitoring an omission of the extraction, reminding the patient of the therapeutic regimen in accordance with a contact preference and a reminder preference.

31. The method according to claim 30, wherein said authorizing step includes authorizing the reminder service to monitor by radio wave, microwave, magnetic impulse, electrical current, short wave, or long wave transmissions.

32. The method according to claim 30, wherein the therapeutic regimen is associated with a prescription medication and step (a) includes:
(i) obtaining, from a provider of the prescription medication, product information associated with the prescription medication;
(ii) assigning a code to the prescription medication associated with the product information; and
(iii) validating the code and providing one of an accepted and rejected status to the provider of the prescription medication in response to a validation request.

33. The method according to claim 12, wherein said providing step includes providing an RFID transmitter.

34. The method according to claim 21, wherein said providing step comprises providing an RFID transmitter for distribution to the patient.

35. The method according to claim 24, wherein said notifying step comprises activating an RFID transmitter to notify the reminder service when the reminder service is not needed.

36. The system of claim 27, wherein said high frequency receiver includes an RFID receiver.

37. The system of claim 29, wherein said high frequency transmitter includes an RFID transmitter.

38. The method according to claim 30, wherein the therapeutic regimen is associated with a prescription medication and step (a) includes:
(i) producing the prescription medication and sending product information corresponding to the prescription medication to a clearing house;
(ii) receiving a code associated with the prescription medication from the clearing house;
(iii) packaging the prescription medication;
(iv) transmitting product information associated with the packaged prescription medication to the clearing house for validation; and
(v) transferring the prescription medication and associated code to one of a wholesaler and a retailer for distribution to patients upon validation according to step (iv).
